(19) United States
(12) Patent Application Publication
(10) Pub. No.: US 2023/0141018 A1
(43) Pub. Date: May 11, 2023

(54) FOAM SPRAYER WITH ADAPTER AND MULTIPLE PRESSURE MODES

(71) Applicant: Energizer Auto, Inc., St. Louis, MO (US)

(72) Inventors: Benjamin W. Rowen, North Olmsted, OH (US); Thanh Ngoc Tran, Meriden, CT (US); Jiang Weicai, Wenling City (CN); Zhang Changyi, Wenling City (CN); Joanna Lynn Celestina, Westlake, OH (US)

(21) Appl. No.: 17/982,764

(22) Filed: Nov. 8, 2022

Related U.S. Application Data
(60) Provisional application No. 63/277,010, filed on Nov. 8, 2021.

(51) Int. Cl. B05B 7/00; B08B 3/00; B05B 7/24

(52) U.S. Cl. CPC B05B 7/005; B08B 3/003; B05B 7/2443

(57) ABSTRACT

A foam sprayer includes a body defining a channel, a nozzle, and an adapter configured to releasably attach to a first fluid source that provides a first fluid at a first pressure. The foam sprayer includes a connector attached to the body and configured to releasably connect the body to the adapter or to a second fluid source that provides a second fluid at a second pressure that is substantially greater than the first pressure. The foam sprayer also includes a mode selection device configured to switch the foam sprayer between a low-pressure mode and a high-pressure mode. The foam sprayer is configured to generate foam from the first fluid when the foam sprayer is in the high-pressure mode. The foam sprayer is configured to generate foam from the second fluid when the foam sprayer is in the high-pressure mode.

### CROSS-REFERENCE TO RELATED APPLICATION

This application claims the benefit of priority to U.S. Provisional Patent Application Ser. No. 63/277,010, entitled “Foam Sprayer with Adapter and Multiple Pressure Modes,” filed Nov. 8, 2021, the content of which is hereby incorporated by reference in its entirety.

### FIELD OF THE DISCLOSURE

The present disclosure relates to a foam sprayer including an adapter configured to attach to a low-pressure fluid source and a high-pressure fluid source.

### BACKGROUND OF THE DISCLOSURE

Foam sprayers are configured to generate foam that is sprayed onto objects such as vehicles for cleaning the objects. Dirt and debris on the objects may be collected by the foam which is removed using a fluid or a cloth. Some foam sprayers are attached to a pressurized fluid source, e.g., a pressure washer, or high-pressure water sprayer, and configured to spray pressurized fluid, such as water, with the foam. The pressurized fluid might provide improved cleaning of the object and facilitate removal of strongly adhered dirt and debris. Other foam sprayers are attached to fluid sources such as a standard garden hose connected to a residential water supply, that do not provide a high-pressure fluid. The low-pressure fluid sources are appropriate for applications where high-pressure fluid could cause damage to the object or where a high-pressure fluid source is not available. However, conventional foam sprayers may not be used with both a high-pressure fluid source and a low-pressure fluid source. As used herein, low pressure refers to a pressure of 120 psi or less and high-pressure refers to a pressure of 500 psi or greater. As a result, people are required to utilize two or more different foam sprayers for applications that require high-pressure and low-pressure spray. Also, conventional foam sprayers may be difficult to attach to or detach from a fluid source. Moreover, the foam sprayers may have complicated settings and be hard to operate.

Accordingly, there is a need for a foam sprayer that is configured to attach to a low-pressure fluid source and a high-pressure fluid source and operate in a high-pressure mode and a low-pressure mode. In addition, the foam sprayer should be simple to operate.

### SUMMARY OF THE DISCLOSURE

In one aspect, a foam sprayer includes a body defining a channel, a nozzle attached to the body and configured to emit foam, and an adapter configured to releasably attach to a first fluid source that provides a first fluid at a first pressure. The foam sprayer includes a connector attached to the body and configured to releasably connect the body to the adapter or to a second fluid source that provides a second fluid at a second pressure that is substantially greater than the first pressure. The foam sprayer also includes a mode selection device mounted to the body and configured to switch the foam sprayer between a low-pressure mode and a high-pressure mode. The foam sprayer is configured to generate foam from the first fluid when the foam sprayer is in the low-pressure mode. The foam sprayer is configured to generate foam from the second fluid when the foam sprayer is in the high-pressure mode.

In another aspect, a spray system includes a first fluid source configured to provide a first fluid at a first pressure, and a second fluid source configured to provide a second fluid at a second pressure. The second pressure is at least five times greater than the first pressure. The spray system also includes a foam sprayer including a body defining a channel, a nozzle attached to the body and configured to emit foam, and a connector attached to the body. The connector is configured to releasably connect to the second fluid source to allow the second fluid from the second fluid source to flow into the channel of the body. The spray system also includes an adapter configured to releasably attach to the connector when the connector is not attached to the second fluid source. The adapter is configured to releasably attach to the first fluid source and direct the first fluid from the first fluid source through the connector and into the channel of the body. The foam sprayer is configured to operate in a low-pressure mode to generate foam from the first fluid, and operate in a high-pressure mode to generate foam from the second fluid.

In yet another aspect, a method of emitting foam from a sprayer includes attaching a first fluid source or a second fluid source to the sprayer. The sprayer includes a body defining a channel, a nozzle configured to emit foam, a connector attached to the body, and an adapter configured to releasably attach to the connector and to the first fluid source to allow a first fluid at a first pressure from the first fluid source to flow into the channel of the body. The connector configured to releasably connect the body to the second fluid source when the adapter is not connected to the connector. The second fluid source provides a second fluid at a second pressure that is greater than the first pressure. The method also includes selecting a low-pressure mode or a high-pressure mode of the sprayer using a mode selection device. The method further includes emitting foam from the sprayer. The sprayer is configured to emit foam from the first fluid when the foam sprayer is in the low-pressure mode. The foam sprayer is configured to emit foam from the second fluid when the foam sprayer is in the high-pressure mode.

### BRIEF DESCRIPTION OF THE DRAWINGS

The accompanying drawings, which are incorporated in and constitute a part of this application, illustrate aspects of the disclosure and together with a written description serve to explain some of the embodiments of the disclosure. A brief description of the drawings is as follows:

FIG. 1 is a partially schematic view of a spray system according to the present disclosure, the spray system including a foam sprayer, a first fluid source, and a second fluid source;

FIG. 2 is a perspective view of one embodiment of the foam sprayer of the system of FIG. 1, the foam sprayer including a body and an adapter, and having a low-pressure mode and a high-pressure mode;

FIG. 3 is a side view of the foam sprayer shown in FIG. 2;

FIG. 4 is an enlarged side view of a portion of the foam sprayer indicated in FIG. 3;

FIG. 5 is a top view of the foam sprayer shown in FIG. 2;

FIG. 6 is a perspective view of the foam sprayer shown in FIG. 2, with the adapter detached from the body of the foam sprayer;

FIG. 7 is a top view of the foam sprayer shown in FIG. 6, with the adapter detached from the body of the foam sprayer;

FIG. 8 is a side view of the foam sprayer shown in FIG. 6, with the adapter detached from the body of the foam sprayer;

FIG. 9 is a front view of the foam sprayer shown in FIG. 6, with the adapter detached from the body of the foam sprayer;

FIG. 10 is a sectional view of the foam sprayer shown in FIG. 6, taken along section line 10-10 of FIG. 9, with the adapter detached from the body of the foam sprayer, the body including a positionable valve and a mixing chamber;

FIG. 11 is an enlarged sectional view of a portion of the body of the foam sprayer indicated in FIG. 10, illustrating the valve in a first position;

FIG. 12 is an enlarged sectional view of a portion of the body of the foam sprayer indicated in FIG. 10, illustrating the valve in a second position;

FIG. 13 is a perspective view of the adapter of the foam sprayer shown in FIG. 2;

FIG. 14 is a side view of the adapter shown in FIG. 13;

FIG. 15 is a front view of the adapter shown in FIG. 13;

FIG. 16 is a sectional view of the adapter shown in FIG. 13, taken along section line 16-16 of FIG. 15;

FIG. 17 is a perspective view of a portion of the spray system shown in FIG. 1, illustrating the foam sprayer attached to the first fluid source;

FIG. 18 is a perspective view of a portion of the spray system shown in FIG. 1, illustrating the foam sprayer attached to the second fluid source; and

FIG. 19 is a perspective view a portion of the spray system shown in FIG. 1, illustrating the first fluid source attached to the adapter of the foam sprayer.

### DETAILED DESCRIPTION

The embodiments of the present disclosure described below are not intended to be exhaustive or to limit the disclosure to the precise forms disclosed in the following detailed description. Rather a purpose of the embodiments chosen and described is so that the appreciation and understanding by others skilled in the art of the principles and practices of the present disclosure may be facilitated.

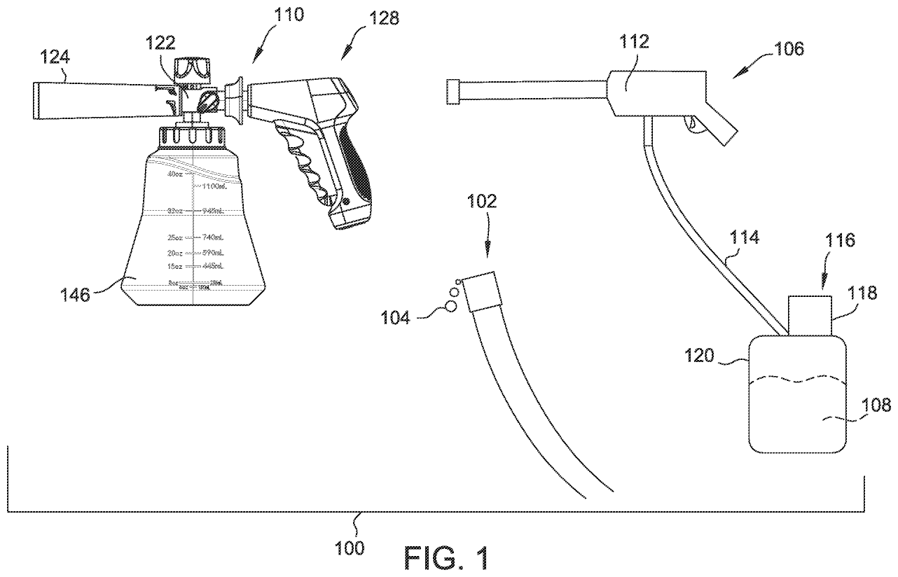

Turning now to the Figures, FIG. 1 is a perspective view of one suitable embodiment of a spray system, indicated generally at 100. For example, the spray system 100 may be configured for spraying an object such as a vehicle with a fluid or a foam for cleaning the object. In embodiments, the vehicle may be an automobile, an aerial vehicle, a watercraft, or any other vehicle. In addition, the foam sprayer 110 is configured to spray other objects such as surfaces, buildings, animals, and structures.

The spray system 100 includes a first fluid source 102 configured to provide a first fluid 104 at a first pressure, a second fluid source 106 configured to provide a second fluid 108 at a second pressure, and a foam sprayer 110. For example, the first fluid source 102 comprises a hose or other conduit for the first fluid 104 to flow through. The first fluid 104 comprises a liquid such as water. The first fluid source 102 is configured to provide the first fluid 104 at a pressure provided by, for example, a municipal water reservoir or other water supply. For example, the first pressure is less than 120 pounds per square inch (psi), such as 120 psi, 110 psi, 100 psi, 90 psi, 80 psi 70 psi, 60 psi or 50 psi.

In the illustrated embodiment, the second fluid source 106 includes a pressurized fluid gun 112 (e.g., a pressure washer), a conduit 114, and a pressure apparatus 116. The pressure apparatus 116 is configured to increase and regulate the pressure of the second fluid 108. The pressure apparatus 116 provides the second fluid 108 at a second pressure that is higher than the first pressure of the first fluid 104. For example, the second pressure is at least 1,000 psi. Accordingly, the second pressure is at least five times greater than the first pressure. The pressure apparatus 116 includes a pump 118 and a tank 120. The tank 120 contains the second fluid 108. The pump 118 is configured to pressurize the second fluid 108 in the tank 120 and provide the second fluid 108 to the pressurized fluid gun 112 at the second pressure. The pump 118 may be any suitable pump. In some embodiments, the pump 118 is motorized. In other embodiments, the pump 118 is manually operated (e.g., a hand pump).

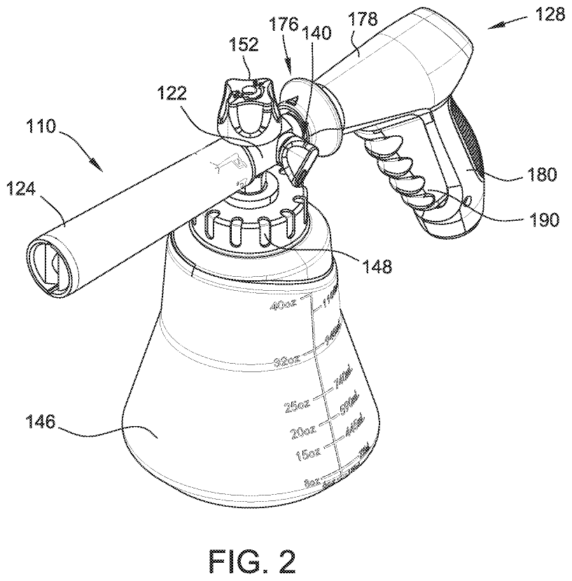

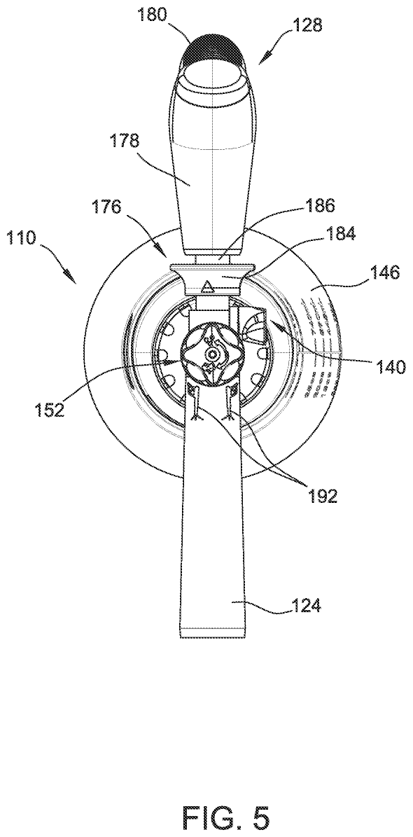

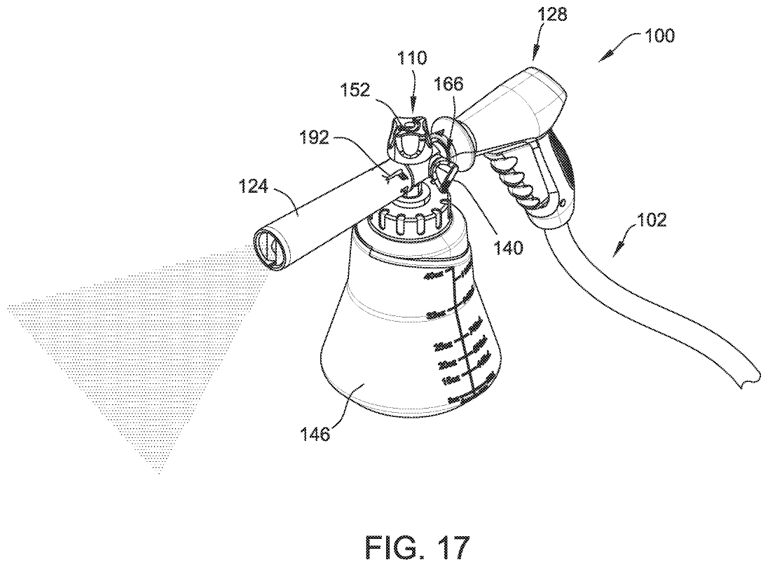

Referring to FIGS. 1-6, the foam sprayer 110 includes a body 122, a nozzle 124 attached to the body 122, a connector 126 attached to the body 122, and an adapter 128. The foam sprayer 110 has multiple pressure modes (e.g., a high-pressure mode and a low-pressure mode) and is configured to attach to the first fluid source 102 or the second fluid source 106. The adapter 128 is connectable to the connector 126 and is configured to releasably connect to the first fluid source 102 to allow the first fluid 104 from the first fluid source 102 to flow into the foam sprayer 110 through the adapter 128, as shown in FIG. 17. The foam sprayer 110 is able to operate in a low-pressure mode when the adapter 128 and the first fluid source 102 are attached to the foam sprayer 110.

The connector 126 is configured to releasably connect to the second fluid source 106 when the adapter 128 is not attached to the connector 126, as shown in FIG. 17. The connector 126 is configured to connect to the pressurized fluid gun 112 to allow the second fluid 108 from the second fluid source 106 to flow into the foam sprayer 110. For example, the connector 126 includes a male engagement piece 130 that is inserted into and engages a tip of the pressurized fluid gun 112. The male engagement piece 130 defines at least one groove 132 that is engaged by the tip of the pressurized fluid gun 112. The foam sprayer 110 is able to operate in a high-pressure mode when the second fluid source 106 is attached to the foam sprayer 110.

The foam sprayer 110 may have a discrete and compact shape and size. For example, an overall length 134 of the foam sprayer 110 may be in a range from 200 millimeters (mm) to 400 mm. In the illustrated embodiment, the overall length 134 of the foam sprayer 110 is 315 mm. The body 122 and the nozzle 124 have a cumulative length 136 in a range of 150 mm to 250 mm. The adapter 128 has a length 138 in a range of 50 mm to 150 mm.

In some embodiments, the nozzle 124 includes one or more nozzle spray tips that are attached to the end of the coupler to control the spray pattern of the first fluid 104 or second fluid 108 that is dispensed from the nozzle 124. The nozzle 124 may include an adjustment device that provides one or more spray settings, for example a wide spray pattern or a narrow spray pattern.

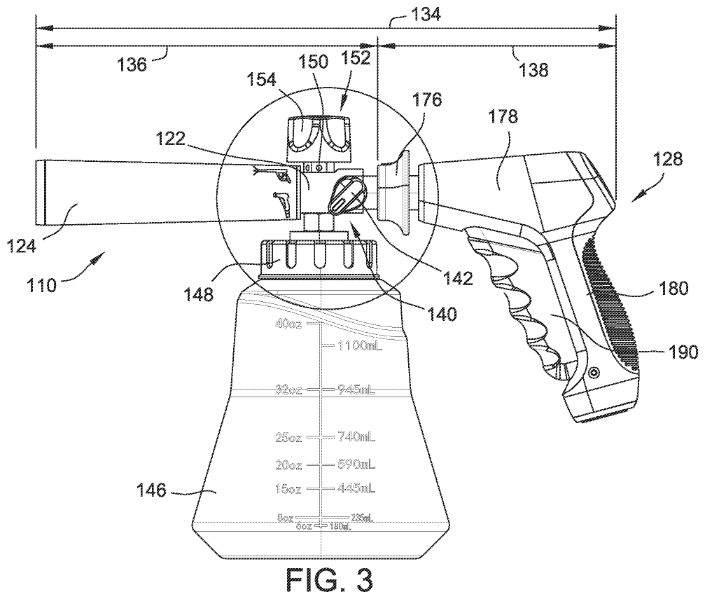

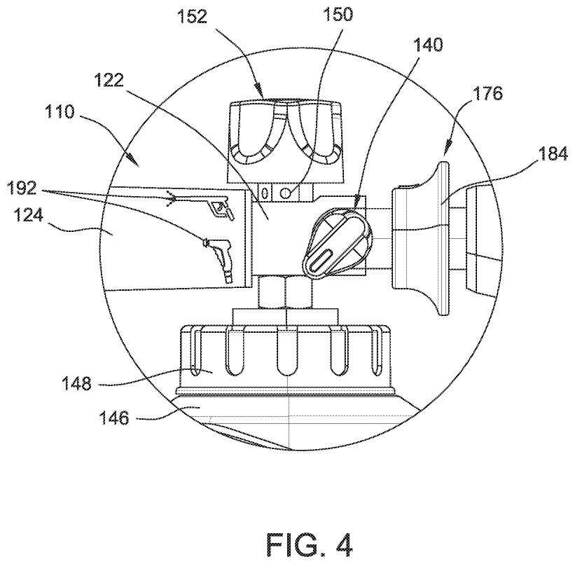

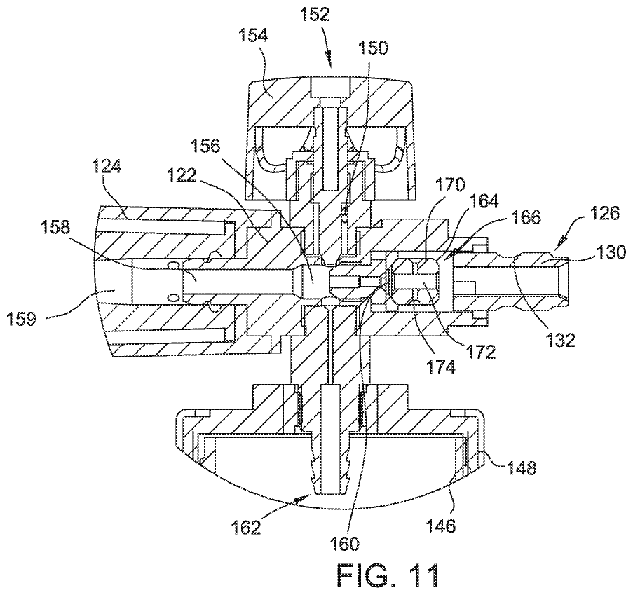

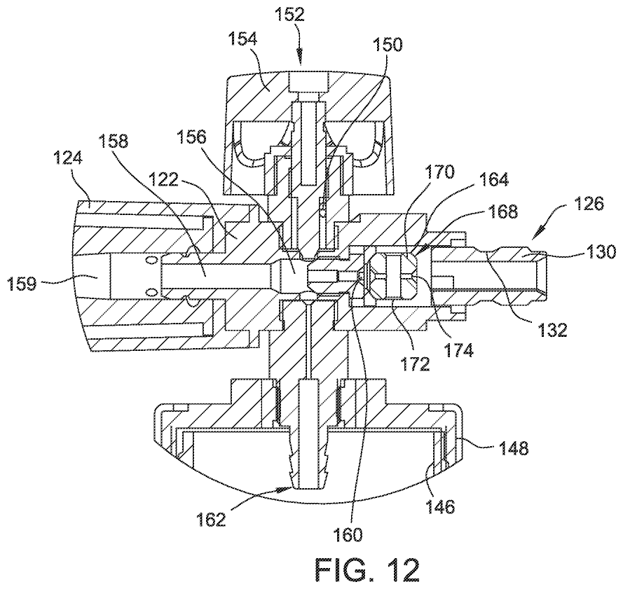

With reference to FIGS. 3 and 4, the foam sprayer 110 includes a mode selection device 140 mounted to the body 122. The mode selection device 140 is configured to switch the foam sprayer 110 between a low-pressure mode and a high-pressure mode. For example, the mode selection device 140 includes a knob 142 and an actuator 144 that are rotatable to switch the foam sprayer 110 between the low-pressure mode and the high-pressure mode. As described in detail herein, the foam sprayer 110 includes a valve 164 (shown in FIGS. 11 and 12) that regulates liquid flow based on the position of the mode selection device 140 such that the foam sprayer 110 is configured to generate foam from the first fluid 104 when the foam sprayer 110 is in the low-pressure mode and generate foam from the second fluid 108 when the foam sprayer 110 is in the high-pressure mode.

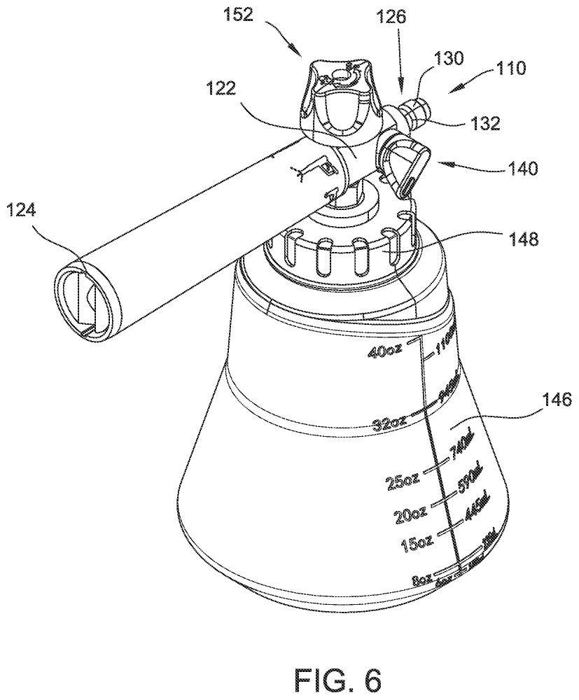

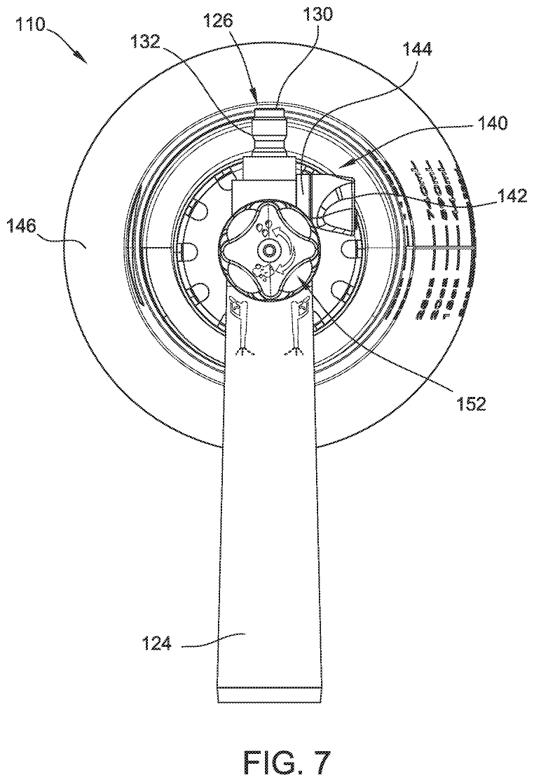

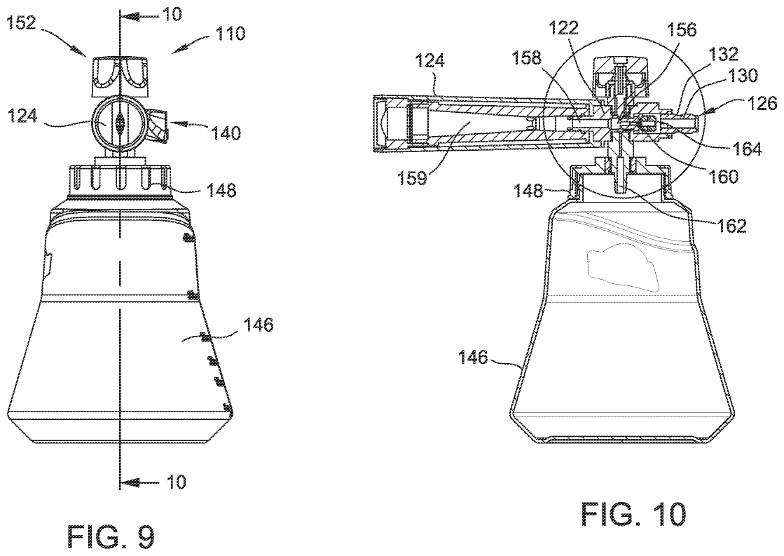

Referring to FIGS. 6-9, the foam sprayer 110 includes a reservoir 146 attached to the body 122. The reservoir 146 is configured to dispense a cleaning agent (e.g. soap) to be mixed with the first fluid 104 or the second fluid 108 within the body 122 to generate foam. In the illustrated embodiment, the reservoir 146 comprises a bottle that is screwed into a collar 148 on a lower portion of the body 122. The reservoir 146 may be removed from the body 122 for filling or replacement of the reservoir 146 by unscrewing the reservoir 146 from the collar 148. The reservoir 146 may be any suitable shape or size. In the illustrated embodiment, the reservoir 146 is constructed of plastic and is configured to contain at least 40 ounces (oz) of cleaning agent. In other embodiments, the reservoir 146 may be sized to contain more or less than 40 oz.

As shown in FIGS. 4 and 10-12, the foam sprayer 110 includes an air intake 150. The air intake 150 is configured to allow air into the body 122 to mix with the cleaning agent and the first fluid or the second fluid. The foam sprayer 110 also includes an intake adjustment device 152 mounted to the body 122. The intake adjustment device 152 is configured to regulate the amount of air that is allowed into the body 122 through the air intake 150. For example, the intake adjustment device 152 includes a knob 154 that is rotated to selectively close or open the air intake 150.

As illustrated in FIGS. 10-12, the body 122 defines a mixing chamber 156 and a channel 158. The mixing chamber 156 is in fluid communication with the reservoir 146 and the air intake 150. Also, the mixing chamber 156 includes an inlet 160 located at the connector 126. The inlet 160 is arranged for the fluid from the fluid source that is connected to the connector 126 to flow into the mixing chamber 156. The mixing chamber 156 is configured to facilitate mixing of the cleaning agent and the fluid. The channel 158 extends from the mixing chamber 156 to the nozzle 124 at a distal end of the body 122. During operation, the cleaning agent and the air are mixed with the first fluid 104 or the second fluid 108 and directed along the channel 158 to generate foam that is emitted from the body 122 through the nozzle 124. The nozzle 124 receives the mixture of the cleaning agent, air, and the first or second fluid 104, 108 and channels the mixture to an outlet at the tip of the nozzle 124 where the foam is emitted. In the example, foam is generated from the mixture at least partly within the nozzle 124. For example, the nozzle 124 includes a foam generating chamber 159 that extends from the channel 158 to the outlet tip of the nozzle 124. In the illustrated embodiment, the foam generating chamber 159 includes an inner diameter that widens out along the extension of the nozzle 124. Therefore, the mixture decreases in pressure within the foam generating chamber 159 and the foam generating chamber 159 facilitates the generation of foam.

The intake adjustment device 152 is positioned at least partly in or on the air intake 150 and allows adjustment of the airflow into the mixing chamber 156 for mixing with the cleaning agent and the first fluid 104 or the second fluid 108. The consistency and concentration of the cleaning agent in the foam are at least partially regulated by the intake adjustment device 152 because airflow into the mixing chamber 156 facilitates the cleaning agent being drawn into the mixing chamber 156 and the cleaning agent forming foam with the fluid. In the example, the body 122 includes a stem 162 that extends into the reservoir 146 for drawing cleaning agent from the reservoir 146 into the mixing chamber 156.

Referring to FIGS. 11 and 12, the mode selection device 140 is connected to a valve 164 located downstream of the connector 126 and upstream of each of the air intake 150, the stem 162 that provides the cleaning agent, the mixing chamber 156, and the channel 158. The valve 164 regulates liquid flow into the mixing chamber 156 through the inlet 160. For example, the valve 164 is rotatable between a first position 166 (shown in FIG. 11) and a second position 168 (shown in FIG. 12). In one embodiment, the valve 164 is rotated approximately 90° to switch between the first position 166 and the second position 168. In other embodiments, the rotation of the valve 164 may be less than or greater than 90 degrees for such operation. The valve 164 is in the first position 166 when the low-pressure mode is selected using the mode selection device 140. The valve 164 is in the second position 168 when the high-pressure mode is selected using the mode selection device 140.

The valve 164 has a body 170 defining a first channel 172 and a second channel 174. The first channel 172 and the second channel 174 are perpendicular to each other. The first channel 172 is in fluid communication with the inlet 160 when the valve 164 is in the first position 166, as shown in FIG. 11. The second channel 174 is in fluid communication with the inlet 160 when the valve 164 is in the second position 168, as shown in FIG. 12. The first channel 172 has a larger cross-sectional area than the second channel 174. For example, in one embodiment, the second channel 174 has a diameter that is no more than 1.5 millimeter (mm) and the first channel 172 has a diameter that is greater than 1.5 mm. In an example, the diameter of the second channel 174 is 1.0 mm and the diameter of the first channel 172 is 3 mm. Accordingly, the first channel 172 is sized for a lower pressure source (e.g., the first fluid source 102) and the second channel 174 is sized for a higher pressure source (e.g., the second fluid source 106).

As a result, the foam sprayer 110 has multiple pressure modes and is able to utilize different fluid sources having different pressures. Moreover, the foam sprayer 110 is simple to operate and the mode selection device 140 and the intake adjustment device 152 provide easy adjustment of the foam sprayer 110. In addition, the valve 164 and the mode selection device 140 provide a simple and reliable adjustment mechanism.

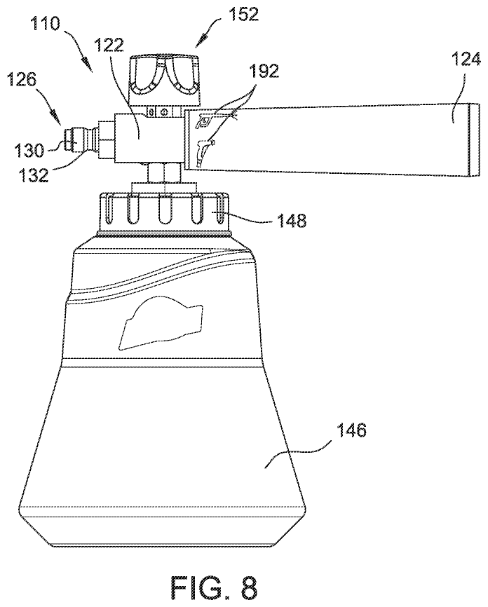

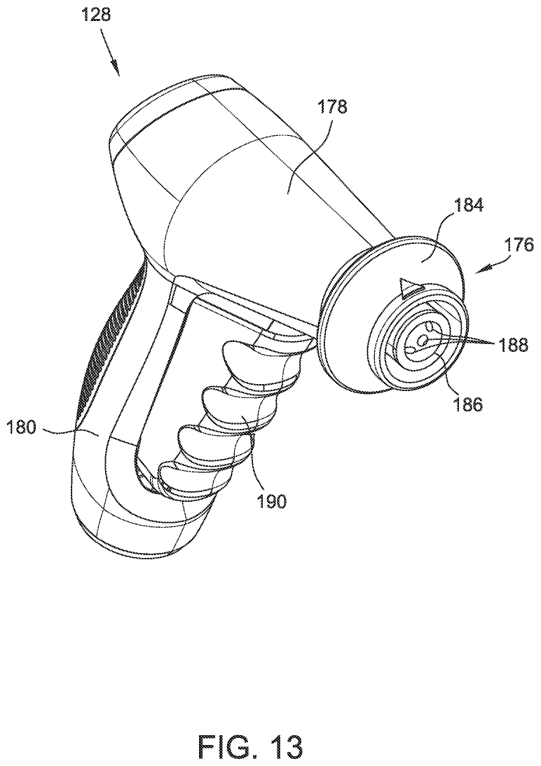

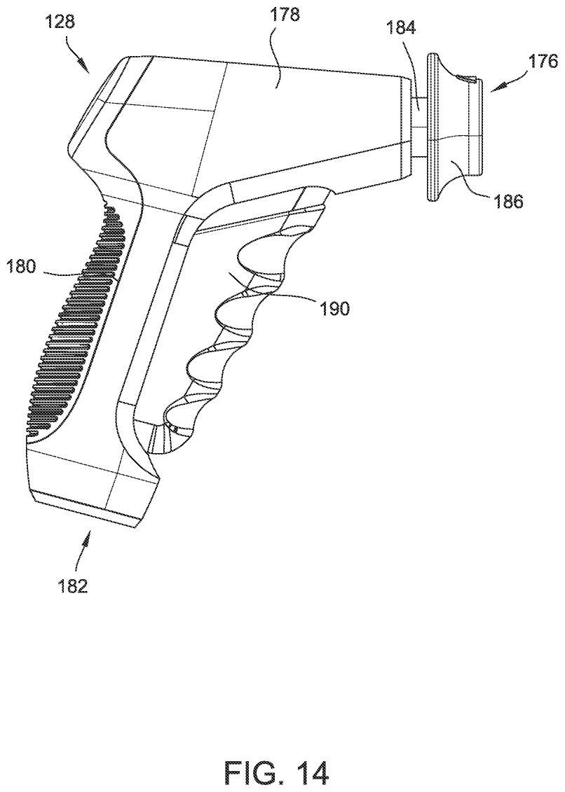

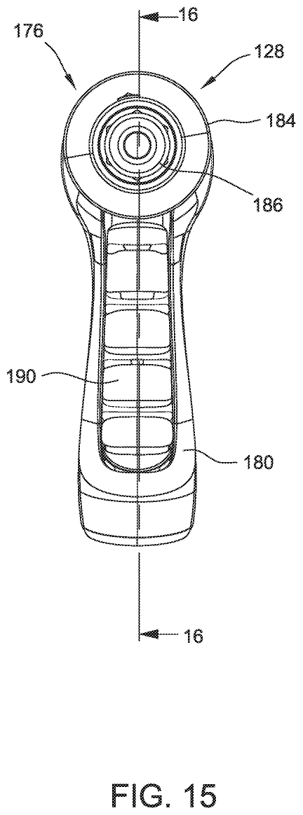

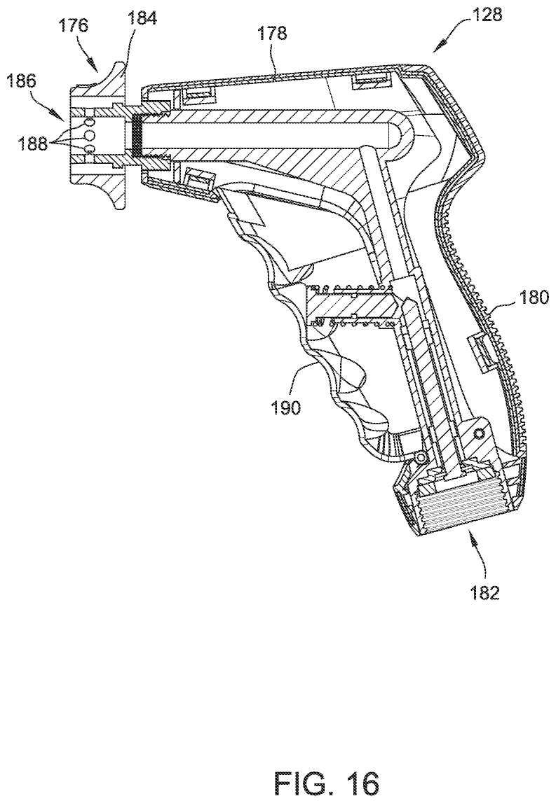

With reference to FIGS. 13-16, the adapter 128 includes a coupler 176, a barrel 178, a handle 180 extending from the barrel 178, and a threaded bore 182. The coupler 176 is disposed on an end of the barrel 178 and is configured to engage the connector 126 (shown in FIG. 8). For example, the coupler 176 includes a collar 184, a sleeve 186 sized to receive the connector 126, and engagement members 188. The collar 184 extends around the sleeve 186 and is positionable between a locked position and an unlocked position. For example, the collar 184 slides axially along the sleeve 186 between the locked position and the unlocked position. The collar 184 may be biased toward the locked position. The engagement members 188 are positioned on the interior of the sleeve 186 and are arranged to engage the connector 126 when the connector 126 is positioned within the sleeve 186 and the collar 184 is in the locked position. For example, the engagement members 188 comprise retractable protrusions that extend into the groove 132 (shown in FIG. 8) in the connector 126. In other embodiments, the adapter 128 may include other couplers 176 without departing from some aspects of the disclosure.

The handle 180 extends at an oblique angle relative to the barrel 178 and is sized for the user to grasp the foam sprayer 110. The threaded bore 182 is disposed at the distal end of the handle 180 opposite the barrel 178 and is configured to threadingly connect to a fluid source (e.g., the first fluid source 102 shown in FIG. 1). The handle 180 includes a trigger 190 for an operator to control fluid flow through the adapter 128 when the fluid source is attached to the threaded bore 182.

Referring to FIGS. 1-12, the foam sprayer 110 may be assembled in any suitable manner. For example, one suitable method of assembling the foam sprayer 110 includes providing the body 122 that defines the channel 158. The nozzle 124 is attached to the body 122 and configured to emit foam. In the illustrated embodiment, the body 122 and the nozzle 124 are constructed as separate pieces and are attached together to assemble the foam sprayer 110. For example, the nozzle 124 is constructed of plastic and the body 122 is constructed of metal. In other embodiments, the body 122 and the nozzle 124 are constructed of the same materials and may be integrally formed as a single piece.

The method also includes attaching the connector 126 to the body 122. For example, in the illustrated embodiment, the connector 126 is metal and is integrally formed with the body 122. In other embodiments, the connector 126 is formed as a separate piece and attached to the body 122 using welds, fasteners, adhesives, or any other suitable attachment. The adapter 128 is releasably attached to the connector 126 to facilitate the first fluid source 102 attaching to the foam sprayer 110. In some embodiments, the adapter 128 is packaged or provided with the foam sprayer 110 but is not attached to the body 122 until use.

In addition, the method includes attaching the mode selection device 140 to the body 122. The mode selection device 140 is rotatably mounted to the body 122 and configured to cause the valve 164 to move between the first position 166 and the second position 168 when the mode selection device 140 is switched between the low-pressure mode and the high-pressure mode. For example, the mode selection device 140 includes the knob 142 that causes the valve 164 to move. The knob 142 is attached to the valve 164 by the actuator 144 extending through an opening in the body 122.

In some embodiments, the method includes attaching the reservoir 146 to the body 122. For example, the reservoir 146 is screwed into the collar 148 of the body 122. The reservoir 146 dispenses a cleaning agent to the body 122.

In further embodiments, the method includes attaching the intake adjustment device 152 to the body 122. For example, the intake adjustment device 152 is rotatably mounted to the body 122. In the illustrated embodiment, rotation of the intake adjustment device 152 selectively opens or closes the air intake 150 and adjusts the concentration of the foam dispersed by the foam sprayer 110.

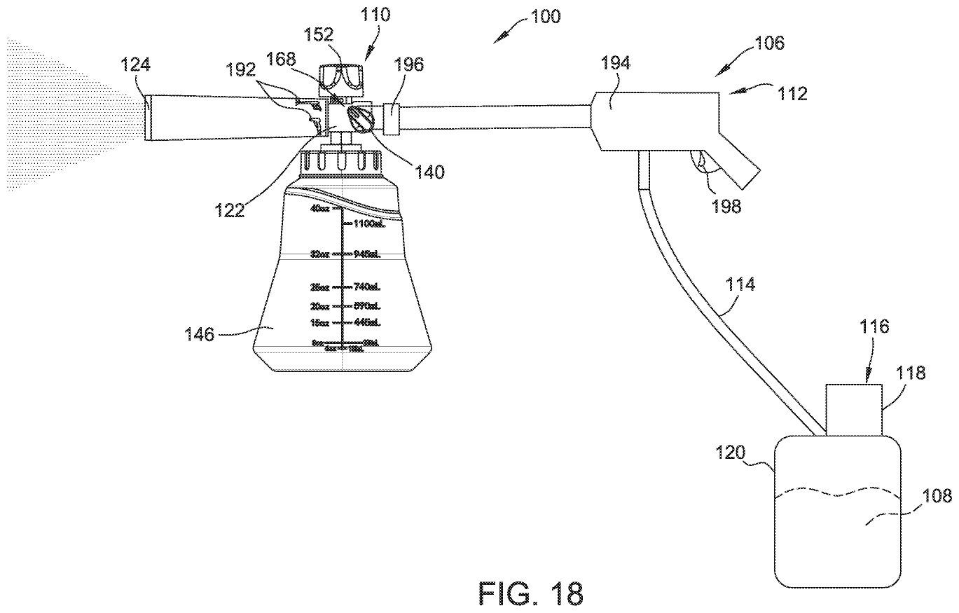

Referring to FIGS. 17 and 18, the foam sprayer 110 is operable in a low-pressure mode (FIG. 17) or a high-pressure mode (FIG. 18). The foam sprayer 110 may include graphics, alpha-numeric characters, lights, or other indicators to facilitate the operator selecting the proper mode. In the illustrated embodiment, the foam sprayer 110 includes illustrations 192 of the fluid sources that correspond to the respective pressure modes.

To operate the foam sprayer 110 in the low-pressure mode, the mode selection device 140 is positioned to select the low-pressure mode as shown in FIG. 17, and the adapter 128 is connected to the body 122 of the foam sprayer 110. The first fluid source 102 is connected to the adapter 128. The trigger 190 of the adapter 128 is actuated to allow the first fluid 104 from the first fluid source 102 to flow into the body 122 of the foam sprayer 110 through the adapter 128. The first fluid source 102 provides the first fluid 104 at the first pressure. The first fluid 104 is mixed with air and the cleaning agent within the body 122 The mixture of the first fluid 104, the air, and the cleaning agent flows through the channel 158 and the nozzle 124 and generates foam. The intake adjustment device 152 is adjusted to regulate the air that flows into the body 122 and, thus, the concentration of the foam. The foam is dispersed from the foam sprayer 110 through the nozzle 124.

To operate the foam sprayer 110 in the high-pressure mode, the adapter 128 is removed from the body 122 of the foam sprayer 110 and the pressurized fluid gun 112 of the second fluid source 106 is connected directly to the body 122. The mode selection device 140 is positioned to select the high-pressure mode as shown in FIG. 18. The trigger 198 of the pressurized fluid gun 112 is actuated to allow the second fluid 108 from the second fluid source 106 to flow into the body 122 of the foam sprayer 110 through the pressurized fluid gun 112. The second fluid source 106 provides the second fluid 108 at the second pressure. The second fluid 108 is mixed with air and the cleaning agent within the body 122. The mixture of the first fluid 108, the air, and the cleaning agent flows through the channel 158 and the nozzle 124 and generates foam. The intake adjustment device 152 is adjusted to regulate the air that flows into the body 122 and, thus, the concentration of the foam. The foam is dispersed from the foam sprayer 110 through the nozzle 124.

The pressurized fluid gun 112 of the second fluid source 106 includes a body 194, a coupler 196, and a trigger 198. The coupler 196 is configured to engage the connector 126 of the foam sprayer 110. For example, the coupler 196 may be similar to the coupler 176 of the adapter 128. The coupler 196 receives and engages the connector 126. Suitably, the pressurized fluid gun 112 is a standard apparatus without modifications and the foam sprayer 110 is compatible with existing types of the pressurized fluid gun 112. In some embodiments, the coupler 196 is a separate piece from the pressurized fluid gun 112 that is provided to facilitate connection of the foam sprayer 110 to the pressurized fluid gun 112.

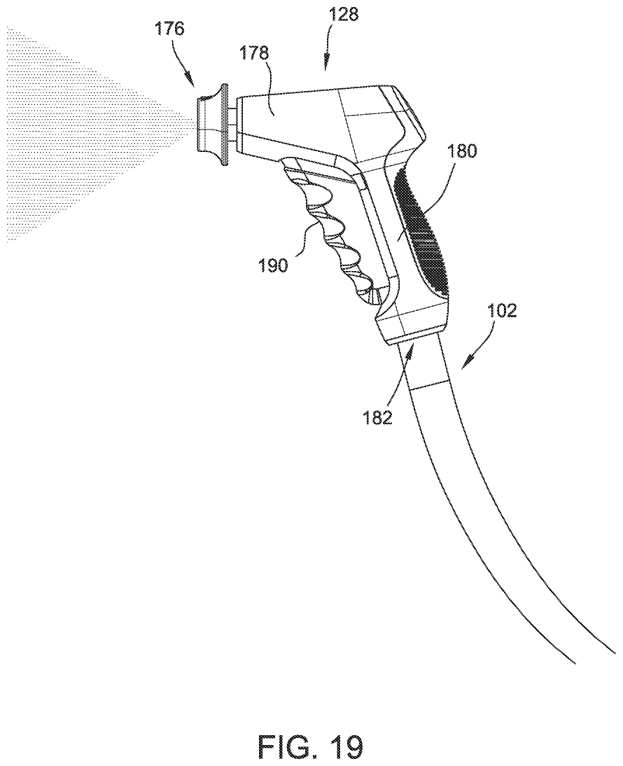

Referring to FIG. 19, the adapter 128 can be used to spray fluid when the adapter 128 is not attached to the body 122 of the foam sprayer 110 (shown in FIG. 1). For example, the adapter 128 is configured to connect to the first fluid source 102 and dispense the first fluid 104 provided by the first fluid source 102 without being attached to the foam sprayer 110. The first fluid source 102 is attached to the bottom of the handle 180. The adapter 128 dispenses the first fluid 104 through the coupler 176 when the trigger 190 is pressed. As a result, the adapter 128 serves multiple purposes and facilitates dispensing the first fluid 104 without generating foam. In other embodiments, the adapter 128 is configured to work with other fluid sources such as the second fluid source 106 (shown in FIG. 1) with or without the foam sprayer 110 attached to the adapter 128. In some embodiments, the adapter 128 includes one or more nozzle spray tips that are attached to the end of the coupler to control the spray pattern of the first fluid 104 that is dispensed from the adapter 128. The adapter 128 may include an adjustment device that provides one or more spray settings.

Compared to conventional spray systems, the spray system of embodiments of the present disclosure has several advantages. For example, embodiments of the spray system include a foam sprayer that is usable with a high-pressure fluid source or a low-pressure fluid source. The foam sprayer has a high-pressure mode and a low-pressure mode. In addition, the foam sprayer includes a connector that is quickly and easily connected to a high-pressure fluid source. Also, the spray system includes an adapter that facilitates connection of a low pressure source and that is configured to dispense low-pressure fluid without the foam sprayer. Moreover, the foam sprayer has a compact shape and size that may provide an improved aesthetic appearance and be easier to handle than other spray systems.

Numerous characteristics and advantages of the embodiments described by this document have been set forth in the foregoing description. As various changes, including modifications to shape, and arrangement of parts, and the like, could be made in the above constructions and methods without departing from the scope of the disclosure, it is intended that all matter contained in the above description and shown in the accompanying drawings shall be interpreted as illustrative and not in a limiting sense. Various modifications, can be made without departing from the spirit and scope of the disclosure.

As used herein, the terms “about,” “substantially,” “essentially” and “approximately” when used in conjunction with ranges of dimensions, concentrations, temperatures or other physical or chemical properties or characteristics is meant to cover variations that may exist in the upper and/or lower limits of the ranges of the properties or characteristics, including, for example, variations resulting from rounding, measurement methodology or other statistical variation.

When introducing elements of the present disclosure or the embodiment(s) thereof, the articles “a,” “an,” “the,” and “said” are intended to mean that there are one or more of the elements. The terms “comprising,” “including,” “containing,” and “having” are intended to be inclusive and mean that there may be additional elements other than the listed elements. The use of terms indicating a particular orientation (e.g., “top,” “bottom,” “side,” etc.) is for convenience of description and does not require any particular orientation of the item described.

What is claimed is:

1. A foam sprayer comprising:
a body defining a channel;
a nozzle attached to the body and configured to emit foam;
an adapter configured to releasably attach to a first fluid source that provides a first fluid at a first pressure;
a connector attached to the body and configured to releasably connect the body to the adapter or to a second fluid source that provides a second fluid at a second pressure that is substantially greater than the first pressure; and
a mode selection device mounted to the body and configured to switch the foam sprayer between a low-pressure mode and a high-pressure mode, wherein the foam sprayer is configured to generate foam from the first fluid when the foam sprayer is in the low-pressure mode, and wherein the foam sprayer is configured to generate foam from the second fluid when the foam sprayer is in the high-pressure mode.

2. The foam sprayer of claim 1, wherein the first pressure of the first fluid is 120 pounds per square inch (psi) or less.

3. The foam sprayer of claim 2, wherein the second pressure of the second fluid is at least 1000 psi.

4. The foam sprayer of claim 1 further comprising a reservoir attached to the body, the reservoir configured to dispense a cleaning agent.

5. The foam sprayer of claim 4, wherein the body includes a mixing chamber that is configured to mix the cleaning agent and the first fluid or the second fluid.

6. The foam sprayer of claim 5, wherein the body includes an air intake configured to allow air to flow into the mixing chamber, wherein the air is mixed with the cleaning agent and the first fluid or the second fluid to generate foam.

7. The foam sprayer of claim 6 further comprising an intake adjustment device configured to regulate the air that is allowed into the mixing chamber through the air intake.

8. The foam sprayer of claim 1, wherein the mode selection device comprises a knob that is rotatable to switch the foam sprayer between the low-pressure mode and the high-pressure mode.

9. A spray system including:
a first fluid source configured to provide a first fluid at a first pressure;
a second fluid source configured to provide a second fluid at a second pressure, wherein the second pressure is at least five times greater than the first pressure; and
a foam sprayer including:
a body defining a channel;
a nozzle attached to the body and configured to emit foam;
a connector attached to the body, the connector configured to releasably connect to the second fluid source to allow the second fluid from the second fluid source to flow into the channel of the body; and
an adapter configured to releasably attach to the connector when the connector is not attached to the second fluid source, the adapter configured to releasably attach to the first fluid source and direct the first fluid from the first fluid source through the connector and into the channel of the body,
wherein the foam sprayer is configured to operate in a low-pressure mode to generate foam from the first fluid, and operate in a high-pressure mode to generate foam from the second fluid.

10. The spray system of claim 9, further comprising a mode selection device configured to switch the foam sprayer between the low-pressure mode and the high-pressure mode.

11. The spray system of claim 9, wherein the first pressure of the first fluid is 120 pounds per square inch (psi) or less.

12. The spray system of claim 11, wherein the second pressure of the second fluid is at least 1000 psi.

13. The spray system of claim 9 further comprising a reservoir attached to the body, the reservoir configured to dispense a cleaning agent to the body.

14. The spray system of claim 13, wherein the body includes a mixing chamber that is configured to mix the cleaning agent and the first fluid or the second fluid.

15. The spray system of claim 14, wherein the body includes an air intake configured to allow air to flow into the mixing chamber, wherein the air is mixed with the cleaning agent and the first fluid or the second fluid to generate foam.

16. The spray system of claim 15 further comprising an intake adjustment device configured to regulate the air that is allowed into the mixing chamber through the air intake.

17. A method of emitting foam from a sprayer, the method comprising:
attaching a first fluid source or a second fluid source to the sprayer, the sprayer including:
a body defining a channel;
a nozzle configured to emit foam;
a connector attached to the body; and
an adapter configured to releasably attach to the connector and to the first fluid source to allow a first fluid at a first pressure from the first fluid source to flow into the channel of the body, the connector configured to releasably connect the body to the second fluid source when the adapter is not connected to the connector, wherein the second fluid source provides a second fluid at a second pressure that is greater than the first pressure;
selecting a low-pressure mode or a high-pressure mode of the sprayer using a mode selection device; and
emitting foam from the sprayer, wherein the sprayer is configured to emit foam from the first fluid when the foam sprayer is in the low-pressure mode, and wherein the foam sprayer is configured to emit foam from the second fluid when the foam sprayer is in the high-pressure mode.

18. The method of claim 17 further comprising attaching a reservoir to the body, the reservoir configured to dispense a cleaning agent to the body, wherein the body includes a mixing chamber that is configured to mix the cleaning agent and the first fluid or the second fluid.

19. The method of claim 18 further comprising adjusting an air intake adjustment device mounted to the body, the air intake adjustment device configured to regulate the air that is allowed into the mixing chamber through an air intake, wherein the air is mixed with the cleaning agent and the first fluid or the second fluid to generate the foam.

20. The method of claim 17, wherein selecting a low-pressure mode or a high-pressure mode using the mode selection device comprises rotating a knob mounted to the body, wherein the knob is rotatable to switch the foam sprayer between the low-pressure mode and the high-pressure mode.
